(19) United States
(12) Patent Application Publication
(10) Pub. No.: US 2006/0247856 A1
(43) Pub. Date: Nov. 2, 2006

(54) Satellite radio based vehicle positioning system

(76) Inventors: Anthony Gerard Lobaza, Bloomfield Hills, MI (US); Brian W. Fillwock, Chesterfield Township, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/117,931

(22) Filed: Apr. 29, 2005

(51) Int. Cl. G01C 21/00

(52) U.S. Cl. 701/213; 701/216

(57) ABSTRACT

A vehicle positioning system architecture according to the invention employs a satellite radio system (“SRS”) to deliver global positioning system (“GPS”) correction data to vehicles. A vehicle having a compatible onboard positioning system receives standard GPS data from GPS satellites, along with SRS signals from SRS satellites and/or SRS terrestrial repeaters. The onboard vehicle positioning system corrects the GPS data with GPS correction data received via the SRS signals.

### TECHNICAL FIELD

The present invention generally relates to vehicle telematics systems. More particularly, the present invention relates to a vehicle positioning system that utilizes global positioning system (“GPS”) and satellite radio system (“SRS”) data.

### BACKGROUND

The prior art is replete with GPS systems and vehicle positioning systems that leverage GPS data. An onboard telematics system that utilizes non-survey grade GPS technology has practical limitations on position availability and accuracy. One example limitation is known as the “urban canyon” problem, which arises when a GPS-enabled vehicle is located in close proximity to tall buildings or other structures. A high level of multipath signals occurs in such an environment due to the reflection of the GPS satellite signals from the structures. In addition, some structures may cause partial or total blockage of the GPS satellite signals. Such blockage can be problematic because a GPS receiver must receive GPS signals from at least three different GPS satellites to obtain a position reading.

To improve location determination, some vehicle positioning systems rely on dead reckoning (“DR”) techniques. DR techniques combine the GPS satellite measurements with additional sources of location information, which may be onboard the vehicle. For example, DR techniques may utilize inertial gyroscopes, accelerometers, compass information, and wheel speed sensors. The prior art contains a number of GPS/DR systems, including GPS/DR systems utilized in vehicle applications. Unfortunately, the use of DR technology in an onboard vehicle application may result in additional cost and complexity to the system.

Military grade GPS systems utilize additional GPS data, e.g., differential GPS data or Wide Area Augmentation System (“WAAS”) data, to improve location determination. The use of differential GPS data and WAAS data reduces known GPS error sources, such as: ionosphere; clock; ephemeris; multipath; troposphere; and receiver errors. Differential GPS data and WAAS data, however, is not readily available for low-cost consumer applications.

Accordingly, it is desirable to have a GPS-based vehicle positioning system which minimizes the need to rely on DR techniques to obtain an accurate position determination. In addition, it is desirable to have a GPS-based vehicle positioning system that operates reliably and accurately in an urban canyon environment. Furthermore, other desirable features and characteristics of the present invention will become apparent from the subsequent detailed description and the appended claims, taken in conjunction with the accompanying drawings and the foregoing technical field and background.

### BRIEF SUMMARY

An onboard vehicle positioning system according to the invention is able to accurately determine the current position of the vehicle using GPS data and GPS correction data transmitted via one or more components of a satellite radio system (“SRS”). The vehicle positioning system is able to generate accurate vehicle position data while minimizing the need to rely on DR technology. In accordance with one practical embodiment of the invention, the vehicle positioning system leverages terrestrial repeaters of the SRS, which enhances reliability in urban canyon environments.

The above and other aspects of the invention may be carried out in one form by an onboard vehicle positioning system having a GPS receiver configured to receive GPS signals originating from GPS satellites, where the GPS signals comprise GPS data, an SRS receiver configured to receive SRS signals originating from a satellite radio broadcast center, where the SRS signals comprise GPS correction data, and processing logic coupled to the GPS receiver and to the SRS receiver. The processing logic is configured to generate current vehicle position data in response to the GPS data and the GPS correction data.

### BRIEF DESCRIPTION OF THE DRAWINGS

The present invention will hereinafter be described in conjunction with the following drawing figures, wherein like numerals denote like elements, and

FIG. 1 is a schematic representation of a satellite-based vehicle positioning system according to an example embodiment of the invention;

FIG. 2 is a schematic representation of an onboard vehicle positioning system according to an example embodiment of the invention;

FIG. 3 is a flow diagram of a GPS correction data communication process according to an example embodiment of the invention; and

FIG. 4 is a flow diagram of a vehicle positioning process according to an example embodiment of the invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of practical vehicle computer system platforms, architectures, and deployments, any number of practical satellite positioning system platforms, architectures, and deployments, and any number of practical satellite radio system platforms, architectures, and deployments, and that the particular system described herein is merely one exemplary application for the invention.

For the sake of brevity, conventional techniques related to vehicle computer modules, vehicle positioning data processing, GPS data and system components, SRS data and system components, digital data communication, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to components or features being “connected” or “coupled” together. As used herein, unless expressly stated otherwise, “connected” means that one component/feature is directly or indirectly connected to another component/feature, and not necessarily mechanically. Likewise, unless expressly stated otherwise, “coupled” means that one component/feature is directly or indirectly coupled to another component/feature, and not necessarily mechanically. Thus, although the schematic block diagrams depict example arrangements of elements, additional intervening elements, devices, features, or components may be present in an actual embodiment (assuming that the functionality of the systems or subsystems are not adversely affected).

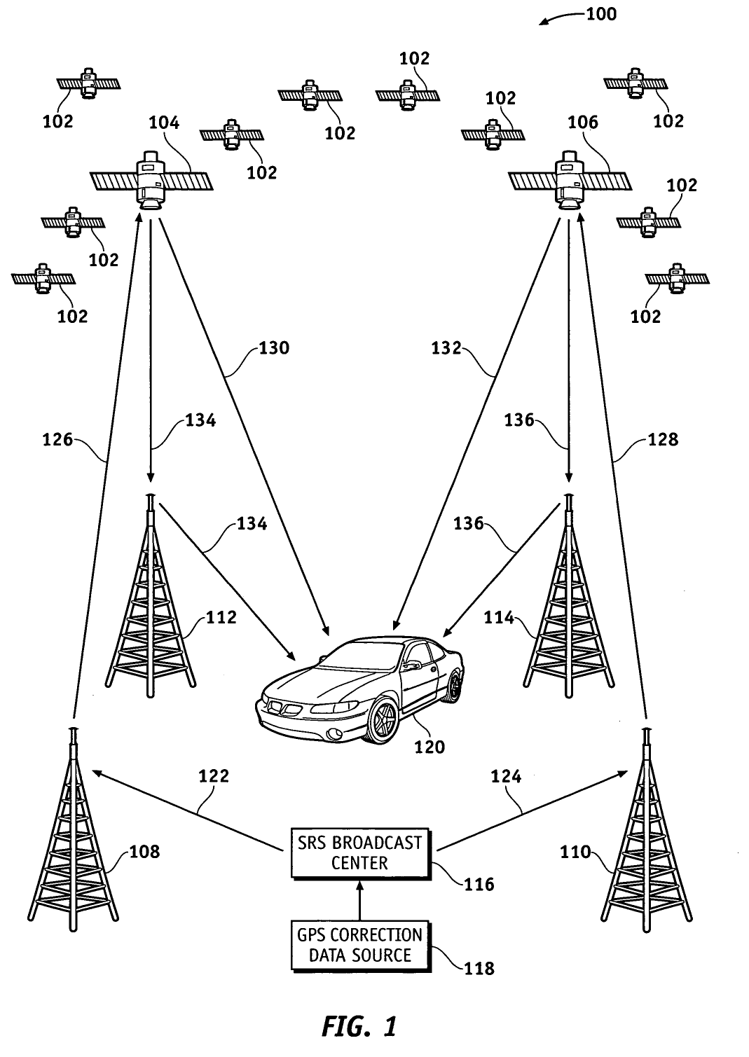

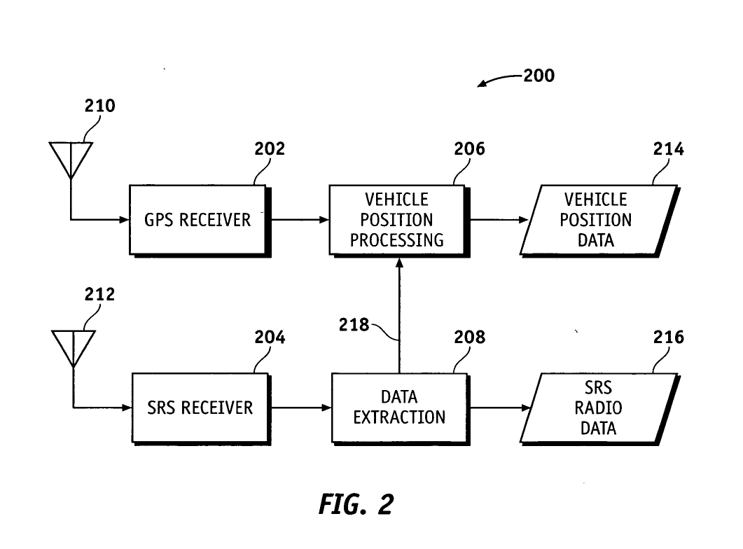

In FIGS. 1 and 2, the various system components may be implemented with physical hardware elements, virtual machines, and/or logical elements. Such system components may utilize general purpose microprocessors, controllers, or microcontrollers that are suitably configured to control the operation of the system described herein, or at least govern the processes described herein. In accordance with the practices of persons skilled in the art of computer programming, the present invention is described herein with reference to symbolic representations of operations that may be performed by various processing or logical components. Such operations are sometimes referred to as being computer-executed, computerized, software-implemented, or computer-implemented. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

FIG. 1 is a schematic representation of a vehicle positioning system 100 configured in accordance with an example embodiment of the invention. System 100 generally includes a plurality of GPS satellites 102, one or more SRS satellites 104/106, one or more SRS uplink stations 108/110, one or more terrestrial repeaters 112/114, an SRS broadcast center 116, a GPS correction data source 118, and a vehicle 120 having an onboard telematics system that includes at least an onboard vehicle positioning subsystem. In a practical deployment, the telematics system may also include telephony, data delivery, navigation, vehicle status monitoring, and media features.

GPS satellites 102 represent satellites that continuously broadcast their position for reception by ground-based GPS receiver components. GPS signals originating at GPS satellites 102 include GPS data indicative of the position of GPS satellites 102. There are currently 24 GPS satellites 102 deployed in orbit; these 24 GPS satellites need not be modified to support vehicle positioning system 100. In practice, each GPS satellite 102 orbits the Earth in a non-geostationary manner. The manner in which GPS satellites 102 communicate with ground-based components is known to those skilled in the art of satellite communications and, therefore, will not be described in detail herein.

SRS satellites 104/106 represent satellites that are deployed in connection with services offered by an SRS provider. One such provider offers commercial SRS services under the name XM Satellite Radio Inc. The commercial SRS system maintained by this provider utilizes two geostationary SRS satellites 104/106 combined with a plurality of terrestrial repeaters 112/114 to broadcast SRS signals to subscribers having a compatible SRS receiver, including onboard vehicle SRS receivers. As described in more detail below, the SRS signals may include GPS correction data combined with the conventional SRS radio data. The manner in which SRS satellites 104/106 communicate with ground-based components is known to those skilled in the art of satellite communications and, therefore, will not be described in detail herein.

SRS broadcast center 116 may be a ground-based center that provides SRS content to other components of the SRS system. It should be appreciated that, although depicted as a distinct block in FIG. 1, SRS broadcast center 116 may be incorporated into one or more of SRS uplink stations 108/110. SRS broadcast center 116 may provide SRS signals to SRS uplink stations 108/110 via suitable data communication links 122/124 (which may include any number of wired and/or wireless sections). In turn, SRS uplink stations 108/110 transmit SRS signals to SRS satellites 104/106 via suitable uplink data communication links 126/128. Thereafter, SRS satellites 104/106 transmit SRS signals to ground-based receiver components for local processing. In this regard, SRS satellites 104/106 may transmit direct SRS signals 130/132 to vehicle 120, and/or indirect SRS signals 134/136 to vehicle 120 via terrestrial repeaters 112/114.

A terrestrial repeater, as the name suggests, is a ground-based component that serves as a relay station for SRS signals. Generally, a terrestrial repeater receives an SRS signal and amplifies it for retransmission at a higher transmit power. A terrestrial repeater may also perform filtering, error correction, or other conditioning of the SRS signal prior to retransmission. Thus, terrestrial repeaters 112/114 enable relatively high power SRS signals to reach vehicle 120 in environments where relatively low power GPS signals from GPS satellites 102 are blocked. Although not shown in FIG. 1, vehicle positioning system 100 may also include intermediate terrestrial repeaters that receive SRS signals from another terrestrial repeater. In this regard, an intermediate terrestrial repeater may relay the SRS signals to another intermediate terrestrial repeater and/or to vehicle 120. Conventional terrestrial repeaters that are currently deployed to support standard SRS systems can be utilized in system 100 without modification.

In accordance with the example embodiment of the invention, SRS signals include GPS correction data. As used herein, “GPS correction data” means any data or information other than the primary GPS data that originates from GPS satellites 102, where such data or information supplements the primary GPS data. For example, GPS correction data may include differential GPS data, such as WAAS data. GPS correction data source 118 represents the processing logic, entity, component, subsystem, file, device, or other element that provides the GPS correction data to SRS broadcast center 116. Although depicted as a distinct block in FIG. 1, GPS correction data source 118 may be incorporated into SRS broadcast center 116.

In practice, the SRS signals also include the conventional SRS radio data. In other words, the SRS signals contain GPS correction data and SRS radio data. The two data types may be transmitted using any suitable data communication technique or protocol that facilitates data separation or extraction by the receiving component.

In a practical deployment, vehicle positioning system 100 may include any number of GPS satellites 102, any number of SRS satellites 104/106, any number of terrestrial repeaters 112/114, and any number of SRS uplink stations 108/110. In addition, system 100 may include more than one SRS broadcast center 116, e.g., one servicing each SRS satellite 104/106. System 100 as depicted in FIG. 1 is merely one simple example used for ease of description.

FIG. 2 is a schematic representation of an onboard vehicle positioning system 200 configured in accordance with an example embodiment of the invention. System 200 may, for example, be deployed in vehicle 120 shown in FIG. 1. System 200 generally includes a GPS receiver 202, an SRS receiver 204, vehicle position processing logic 206 coupled to GPS receiver 202, and data extraction processing logic 208 coupled to SRS receiver 204 and to vehicle position processing logic 206. System 200 may also include a GPS antenna 210 coupled to GPS receiver 202, where GPS antenna 210 is suitably configured to receive GPS signals, and an SRS antenna 212 coupled to SRS receiver 204, where SRS antenna 212 is suitably configured to receive SRS signals. In the example embodiment, system 200 is configured to generate vehicle position data 214 indicative of the current location of the vehicle, and SRS radio data 216 that represents audio and/or video content suitable for playback by the vehicle audiovisual system. In practice, system 200 may be incorporated into an onboard vehicle telematics system, and the elements of system 200 may be realized with any number of physical components. Indeed, GPS receiver 202, SRS receiver 204, vehicle position processing logic 206, and data extraction processing logic 208 may be realized as hardware, software, and/or firmware in a single physical component. For example, GPS receiver 202 and SRS receiver 204 may be combined into an integrated receiver assembly. Furthermore, although FIG. 2 depicts two separate antenna components, GPS antenna 210 and SRS antenna 212 may be realized as a single antenna arrangement in a practical embodiment.

GPS receiver 202 is suitably configured to receive, via GPS antenna 210, GPS signals originating from GPS satellites. As mentioned above, the GPS signals processed by GPS receiver 202 include GPS data. This GPS data may be considered as the “primary” or “baseline” GPS data from which system 200 derives the current location of the vehicle. The GPS data may be passed to vehicle position processing logic 206 for further processing as described below. SRS receiver 204 is suitably configured to receive, via SRS antenna 212, SRS signals originating from an SRS broadcast center (such as SRS broadcast center 116). Depending upon the particular system architecture, the location of the vehicle, and other practical considerations, SRS signals received by SRS receiver 204 may be transmitted by SRS satellites 104/106, terrestrial repeaters 112/114, or other components or subsystems of system 100. As mentioned above, the SRS signals processed by SRS receiver 204 include GPS correction data (and possibly SRS radio data).

Data extraction processing logic 208 is suitably configured to separate or extract the GPS correction data from the received SRS signals. In this regard, data extraction processing logic 208 may perform any number of data communication techniques to isolate the GPS correction data. The GPS correction data (identified by reference number 218) may be passed to vehicle position processing logic 206 to enable adjustment and/or correction of the primary GPS data. In one practical embodiment, vehicle position processing logic 206 adjusts/corrects the GPS data in accordance with the GPS correction data to generate the current vehicle position data 214. The specific manner in which vehicle position processing logic 206 adjusts the primary GPS data may vary from one system to another.

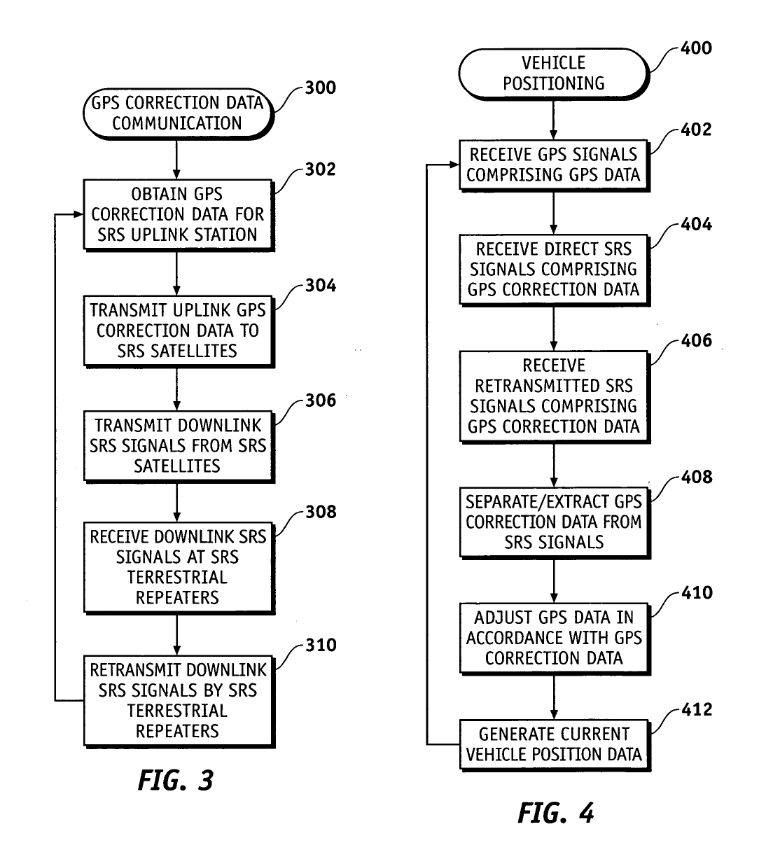

FIG. 3 is a flow diagram of a GPS correction data communication process 300 according to an example embodiment of the invention. Process 300 is generally directed to the handling of GPS correction data by an SRS provider. It should be appreciated that the various tasks performed in connection with process 300 may be performed by software, hardware, firmware, or any combination thereof. For illustrative purposes, the following description of process 300 may refer to elements mentioned above in connection with FIG. 1. In practical embodiments, portions of process 300 may be performed by different elements of the described system, including, without limitation, the SRS broadcast center, the SRS uplink stations, or the terrestrial repeaters. It should also be appreciated that process 300 may include any number of additional or alternative tasks, the tasks shown in FIG. 3 need not be performed in the illustrated order, and process 300 may be incorporated into a more comprehensive procedure or process having additional functionality not described in detail herein.

GPS correction data communication process 300 begins by obtaining GPS correction data for an SRS uplink station (task 302). As described above, the GPS correction data may be differential GPS data, such as WAAS data, obtained from any available source. In practice, the GPS correction data is provided to an SRS broadcast center for processing along with the normal SRS radio data. Ultimately, the GPS correction data is sent to the SRS uplink station, which then uplink transmits the GPS correction data to one or more SRS satellites (task 304). In a practical embodiment, the GPS correction data may be combined with (or included with) SRS radio data in suitably formatted SRS signals. The SRS uplink station may transmit the SRS signals and/or the GPS correction data to the SRS satellites using techniques and protocols known to those skilled in satellite data communications.

The SRS satellites perform downlink transmission of SRS signals (task 306), where the SRS signals comprise the GPS correction data. The SRS satellites may transmit the SRS signals and/or the GPS correction data using techniques and protocols known to those skilled in satellite data communications. Indeed, the SRS satellites need not be modified to support GPS correction data communication process 300. As mentioned above, some SRS signals may be directly transmitted from an SRS satellite to the receiving vehicle, while other SRS signals may be indirectly transmitted to the receiving vehicle via one or more terrestrial repeaters.

If a terrestrial repeater is included in the data transmission path, then downlink SRS signals comprising GPS correction data are received by the terrestrial repeater (task 308). The terrestrial repeater may perform conditioning or processing of the received SRS signal before retransmitting the downlink SRS signal (task 310). As described above, such retransmission may be directed to another terrestrial repeater and/or to the receiving vehicle. Notably, the transmission of SRS signals occurs in a broadcast manner and without any specific receiving vehicle or component as a destination.

FIG. 4 is a flow diagram of a vehicle positioning process 400 according to an example embodiment of the invention. Process 400 is generally directed to the handling of satellite-based positioning data by an onboard vehicle telematics system, e.g., a vehicle positioning system as described above. It should be appreciated that the various tasks performed in connection with process 400 may be performed by software, hardware, firmware, or any combination thereof. For illustrative purposes, the following description of process 400 may refer to elements mentioned above in connection with FIG. 2. In practical embodiments, portions of process 400 may be performed by different elements of the described system, including, without limitation, GPS receiver 202, SRS receiver 204, vehicle position processing logic 206, or data extraction processing logic 208. It should also be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

Vehicle positioning process 400 may begin by receiving, via the onboard vehicle subsystem, GPS signals originating from GPS satellites (task 402). The GPS signals comprise GPS data, as explained above. In addition, the onboard vehicle subsystem also receives SRS signals originating from an SRS broadcast center. The SRS signals comprise GPS correction data and SRS radio data, as explained above. In practice, the onboard vehicle subsystem may receive direct SRS signals transmitted from SRS satellites (task 404) and/or retransmitted SRS signals transmitted from terrestrial repeaters (task 406).

The onboard vehicle subsystem may process the received SRS signals to separate or extract the GPS correction data from the SRS signals (task 408) and/or to separate or extract the SRS radio data from the SRS signals. The SRS radio data can then be processed in a conventional manner to facilitate playback by the vehicle audiovisual system. The extracted GPS correction data may then be utilized to adjust or correct the primary GPS data (task 410) using suitable correction techniques. In other words, the primary GPS data received during task 402 is adjusted in accordance with the GPS correction data. In addition, the onboard vehicle subsystem generates current vehicle position data based on the corrected GPS data (task 412). In this regard, the current vehicle position data is generated in response to the primary GPS data and in response to the GPS correction data.

The onboard vehicle subsystem may employ post-processing or real-time timing methods to synchronize the GPS correction data with the primary GPS data. Briefly, one possible post-processing technique is performed as follows: (1) the SRS uplink station calculates range corrections and time tags its uplink transmissions; (2) the onboard vehicle subsystem time tags the currently measured ranges to the SRS satellites; and (3) at a defined later point in time, both the SRS uplink station and the onboard vehicle subsystem can download their respective time tagged information to onboard telematics systems for use in connection with enhanced vehicle positioning.

For precise navigation applications, the real-time technique is preferred to eliminate time delays that may be associated with the post-processing technique. One possible example of real-time processing begins with the SRS uplink station periodically (e.g., every second) sending the GPS correction data to the onboard vehicle subsystem. This may be accomplished via a direct transmission to the vehicle or via the SRS satellites. Once the onboard vehicle subsystem receives this information, it can be processed with the real-time GPS data to provide the improved location measurement for the vehicle.

In a practical embodiment of the invention, the current vehicle position data may be further processed by the onboard vehicle subsystem to facilitate rendering or display of the current vehicle position in connection with, e.g., an onboard navigation system. Alternatively (or additionally), the current vehicle position data may be further processed by the onboard vehicle subsystem to facilitate transmission to a monitoring service or to facilitate onboard storage. As depicted by the arrow from task 412 to task 402, vehicle positioning process 400 may be a continuous process that repeats itself to enable real-time updating of the vehicle position.

In summary, an onboard vehicle positioning system according to the invention leverages the reliable coverage range and relatively high transmit power of an SRS system to provide enhanced GPS-based location determination. The system is capable of providing an enhanced location in an urban canyon environment where conventional GPS satellite signal transmissions may be highly reflected and/or completely blocked. Furthermore, the system utilizes the SRS system to convey GPS correction data, such as differential GPS data, that improves the accuracy of standard GPS location readings.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for determining the position of a vehicle, said method comprising:
receiving, via an onboard vehicle subsystem, global positioning system (“GPS”) signals originating from GPS satellites, said GPS signals comprising GPS data;
receiving, via said onboard vehicle subsystem, satellite radio system (“SRS”) signals originating from a satellite radio broadcast center, said SRS signals comprising GPS correction data; and
generating current vehicle position data in response to said GPS data and said GPS correction data.

2. A method according to claim 1, wherein receiving SRS signals comprises receiving SRS signals transmitted from at least one SRS terrestrial repeater.

3. A method according to claim 1, wherein receiving SRS signals comprises receiving SRS signals transmitted from at least one SRS satellite.

4. A method according to claim 1, wherein generating current vehicle position data comprises adjusting said GPS data in accordance with said GPS correction data.

5. A method according to claim 1, said GPS correction data comprising differential GPS data.

6. A method according to claim 5, said differential GPS data comprising Wide Area Augmentation System (“WAAS”) data.

7. A method according to claim 1, said SRS signals further comprising satellite radio data.

8. A method according to claim 1, further comprising separating said GPS correction data from said SRS signals.

9. An onboard vehicle positioning system comprising:
a global positioning system (“GPS”) receiver configured to receive GPS signals originating from GPS satellites, said GPS signals comprising GPS data;
a satellite radio system (“SRS”) receiver configured to receive SRS signals originating from a satellite radio broadcast center, said SRS signals comprising GPS correction data; and
processing logic coupled to said GPS receiver and to said SRS receiver, said processing logic being configured to generate current vehicle position data in response to said GPS data and said GPS correction data.

10. A system according to claim 9, said GPS receiver and said SRS receiver being combined into an integrated receiver assembly.

11. A system according to claim 9, said processing logic being configured to generate said current vehicle position data by adjusting said GPS data in accordance with said GPS correction data.

12. A system according to claim 9, said GPS correction data comprising differential GPS data.

13. A system according to claim 12, said differential GPS data comprising Wide Area Augmentation System (“WAAS”) data.

14. A system according to claim 9, said SRS signals further comprising satellite radio data, and said SRS receiver being configured to process said satellite radio data.

15. A system according to claim 14, further comprising data extraction processing logic coupled to said SRS receiver, said data extraction processing logic being configured to separate said GPS correction data from said satellite radio data.

16. A method for providing positioning information to vehicles supported by a vehicle positioning system, said method comprising:
obtaining global positioning system (“GPS”) correction data for a satellite radio system (“SRS”) uplink station;
uplink transmitting said GPS correction data from said SRS uplink station to at least one SRS satellite; and
downlink transmitting SRS signals from said at least one SRS satellite, said SRS signals comprising said GPS correction data.

17. A method according to claim 16, further comprising:
receiving, by at least one SRS terrestrial repeater, a downlink SRS signal containing GPS correction data; and
retransmitting, by said at least one SRS terrestrial repeater, said downlink SRS signal.

18. A method according to claim 16, said GPS correction data comprising differential GPS data.

19. A method according to claim 18, said differential GPS data comprising Wide Area Augmentation System (“WAAS”).

20. A method according to claim 18, said SRS signals further comprising satellite radio data.
